(19) United States
(12) Patent Application Publication
(10) Pub. No.: US 2019/0200439 A1
(43) Pub. Date: Jun. 27, 2019

(54) ENERGY HAVESTERS AS USER INTERFACES

(71) Applicant: PHILIPS LIGHTING HOLDING B.V., EINDHOVEN (NL)

(72) Inventors: HARRY BROERS, 'S-HERTOGENBOSCH (NL); RUBEN RAJAGOPALAN, NEUSS (DE); LIANG SHI, SHANGHAI (CN); THEODORUS JOHANNES PETRUS VAN DEN BIGGELAAR, VELDHOVEN (NL)

(21) Appl. No.: 16/306,661

(22) PCT Filed: May 22, 2017
(86) PCT No.: PCT/EP2017/062248

§ 371 Date: Dec. 3, 2018

(30) Foreign Application Priority Data
Jun. 3, 2016 (CN) PCT/CN2016/084731

(51) Int. Cl. H05B 37/02; G06F 3/01; H02S 40/20; H05B 33/08; H02J 7/35

(52) U.S. Cl. CPC H05B 37/0272; H05B 37/0227; H02J 7/35; H02S 40/20; H05B 33/0845; G06F 3/017

(57) ABSTRACT

In various embodiments, an energy harvesting unit (102, 402, 502, 602, 702, 902) may be configured to convert captured light into current. Logic (104, 404, 504, 604, 704, 904) operably coupled with the energy harvesting unit may be configured to detect a current fluctuation at the energy harvesting unit. The current fluctuation may be caused by a corresponding fluctuation in light captured by the energy harvesting unit. The logic may be further configured to determine that the detected current fluctuation matches a predefined current fluctuation pattern associated with deliberate modulation of light captured by the energy harvesting unit. In some embodiments, the logic may generate appliance control data for controlling one or more appliances (120, 130, 132) based on the matching predefined current fluctuation pattern. In some embodiments, the logic may control light output by one or more light sources (960).

### TECHNICAL FIELD

The present invention is directed generally to controlling appliances. More particularly, various inventive methods and apparatus disclosed herein relate to utilizing energy harvesters as user interfaces for controlling appliances such as light sources.

### BACKGROUND

Many appliances such as so-called “intelligent lighting units/luminaires” may be controlled with user interfaces such as wall switches that are external to, but in communication with, the appliances, e.g., over one or more wired or wireless networks. Some such user interfaces are powered by uninterrupted power sources such as A/C mains. Some outdoor luminaires work exclusively on solar power. Because of the absence of mains connection, controlling these lights e.g. on/off switching of the light must happen on the luminaire with an extra switch or via a wireless connection.

However, installation and wiring of such interfaces may be costly. Other external user interfaces, such as wireless wall switches commonly deployed to control one or more light sources of a lighting system, may depend on battery power. Some such user interfaces may include energy harvesting units such as solar panels to harvest energy that can then be stored in a battery and used, for instance, to detect operation of the user interfaces and/or to transmit appliance control data (e.g., lighting control commands) to one or more appliances. Many external user interfaces include control elements such as switches, knobs, sliders, capacitive touchpads, and so forth, that may be manipulable by a user to control one or more appliances. However, these control elements may be relatively costly in terms of manufacturing (e.g., in the case of physical knobs, switches, sliders, etc.) and/or power usage (e.g., in the case of capacitive touch pads). Thus, there is a need in the art to leverage energy harvesting units themselves to facilitate user control of appliances.

### SUMMARY

The present disclosure is directed to inventive methods and apparatus for utilizing energy harvesters as user interfaces for controlling appliances such as light sources. For example, a wireless wall switch operable to control one or more light sources of a lighting system may be provided with a solar panel. The solar panel may serve two purposes: (i) harvesting energy to be used to transmit data to remote devices (e.g., by generating current); and (ii) for use in detecting deliberate user modulation of light captured by the energy harvesting unit. Logic associated with the wall switch, a lighting system controller, or another computing device, may be configured to detect fluctuation of current generated by the energy harvesting unit that is caused by the deliberate modulation of light. This deliberate modulation of light may be caused, for instance, by a user temporarily blocking the solar panel with his or her hand, which may cause an abrupt drop in current generated by the energy harvesting unit. Or as a more complex example, a user may perform one or more gestures in between the solar panel and one or more sources of light (e.g., sunlight, artificial light). Those gestures may modulate the captured light in a manner that causes corresponding current fluctuations at the energy harvesting unit. Based on a similarity between detected current fluctuations and predefined “current fluctuation patterns,” the logic may generate “appliance control data” that, when transmitted to one or more appliances such as one or more light sources, cause the one or more appliances to operate in a particular manner. In another aspect, in solar-powered luminaires configured with selected aspects of the present disclosure, the solar panel used as both an energy harvesting device and a user interface, e.g., to detect gesture control. Thus, for instance, a user may wave her hand in front of the solar panel of the solar-powered luminaire to turn it on or off, or to otherwise control one or more properties of light emitted by the solar-powered luminaire.

Generally, in one aspect, an appliance control apparatus may include: an energy harvesting unit to convert captured light into current; logic operably coupled with the energy harvesting unit; and a communication interface. In various embodiments, the logic is configured to: detect a current fluctuation at the energy harvesting unit, the current fluctuation caused by a corresponding fluctuation in light captured by the energy harvesting unit; determine that the detected current fluctuation matches a predefined current fluctuation pattern associated with deliberate modulation of light captured by the energy harvesting unit; generate appliance control data based on the matching predefined current fluctuation pattern; and transmit the appliance control data through the communication interface to one or more appliances.

In various embodiments, the appliance may include memory operably coupled with the logic to store one or more predefined current fluctuation patterns. The logic may be configured to compare the detected fluctuation in current to the one or more predefined current fluctuation patterns.

In some embodiments the energy harvesting unit includes an operation energy harvesting unit with a first field of view. The appliance control apparatus may further include a reference energy harvesting unit to convert captured light into current, wherein the reference energy harvesting unit may have a second field of view that is different than the first field of view. In various versions, the second field of view may be selected so that the reference energy harvesting unit continues to capture ambient light while light captured by the operation energy harvesting unit is interrupted. In various versions, the logic is further configured to: compare current provided by the operation energy harvesting unit to current provided by the reference energy harvesting unit; and generate appliance control data based at least in part on the comparison.

In various embodiments, the appliance control data may include lighting control commands, and the one or more appliances comprise one or more light sources. In various embodiments, the communication interface is a wireless communication interface. In some embodiments, the appliance may include an optical element positioned at least partially within a field of view of the energy harvesting component. The optical element may be adjustable to alter a manner in which light reaches the energy harvesting component. In some embodiments, the optical element may include one or more polarizers. In some embodiments, the optical element may include one or more shutters.

In some embodiments, the appliance may include a light source operably coupled with the logic, wherein light emitted by the light source is captured by the energy harvesting component. In some embodiments, the current fluctuation may be a current increase that corresponds to an increase in light captured by the energy harvesting unit. In some embodiments, the increase in light captured by the energy harvesting unit may be caused by light emitted by the light source and reflected from a user's hand.

In some embodiments, the energy harvesting unit may include a plurality of solar cells, each solar cell configured to generate current from captured light. The logic may be configured to determine a direction of the deliberate modulation of light captured by the energy harvesting unit based on currents generated by the plurality of solar cells.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of approximately 700 degrees K (typically considered the first visible to the human eye) to over 10,000 degrees K; white light generally is perceived at color temperatures above 1500-2000 degrees K.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “logic” is used herein generally to describe various apparatus relating to the operation of one or more light sources. Logic can be implemented in numerous ways (e.g., such as with dedicated hardware) to perform various functions discussed herein. A “processor” is one example of logic which employs one or more microprocessors that may be programmed using software (e.g., microcode) to perform various functions discussed herein. Logic may be implemented with or without employing a processor, and also may be implemented as a combination of dedicated hardware to perform some functions and a processor (e.g., one or more programmed microprocessors and associated circuitry) to perform other functions. Examples of logic components that may be employed in various embodiments of the present disclosure include, but are not limited to, conventional microprocessors, application specific integrated circuits (ASICs), and field-programmable gate arrays (FPGAs).

In various implementations, a processor or logic may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or logic, perform at least some of the functions discussed herein. Various storage media may be fixed within a processor or logic or may be transportable, such that the one or more programs stored thereon can be loaded into a processor or logic so as to implement various aspects of the present invention discussed herein. The terms “program” or “computer program” are used herein in a generic sense to refer to any type of computer code (e.g., software or microcode) that can be employed to program one or more processors or logic.

The term “addressable” is used herein to refer to a device (e.g., a light source in general, a lighting unit or fixture, a processor or logic associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as logic for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including logic or processors) that facilitates the transport of information (e.g., for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

An “energy harvesting unit” as used herein may refer to a device that harvests energy from one or more environmental stimuli and makes that energy available for use in various applications. One common type of an energy harvesting unit is a photovoltaic energy harvesting unit that converts light into direct current electricity. These may include, for instance, a solar panel or “cell” (also referred to as a “photocell”) that is configured to capture natural and/or artificial light and convert that light into energy, e.g., by generating current for storage in a battery. Other types of energy harvesting units may harvest energy from other environmental stimuli. For example, a kinetic energy harvesting unit may harvest energy from movement. Other types of energy harvesting units may generate energy from air/water pressure, temperature differences, and so forth.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 schematically illustrates an example environment in which components configured with selected aspects of the present disclosure may be operated, in accordance with various embodiments.

FIG. 2 depicts example experimental results of current that is generated at a solar cell when exposed to various ambient light levels.

FIG. 3 depicts a table that includes recommended guidelines for illumination while participating in various activities.

FIGS. 4-7 depict various embodiments of user interface components configured with selected aspects of the present disclosure, in accordance with various embodiments.

FIG. 8 depicts an example method of controlling appliances using energy harvesting units, in accordance with various embodiments.

FIG. 9 depicts another embodiment in which a solar-powered luminaire is configured with selected aspects of the present disclosure, in accordance with various embodiments.

### DETAILED DESCRIPTION

Many appliances may be controlled with user interfaces such as wall switches that are external to, but in communication with, the appliances, e.g., over one or more wired or wireless networks. Some user interfaces such as wireless wall switches commonly installed to wirelessly control one or more light sources of a lighting system may depend on battery power. Some battery-powered user interfaces may include energy harvesting units such as solar panels to harvest energy that can then be stored in a battery and used, for instance, to detect operation of the user interfaces and/or to transmit appliance control data (e.g., lighting control commands) to one or more appliances. Applicants have recognized and appreciated that it would be beneficial to further leverage energy harvesting units to facilitate user control of appliances.

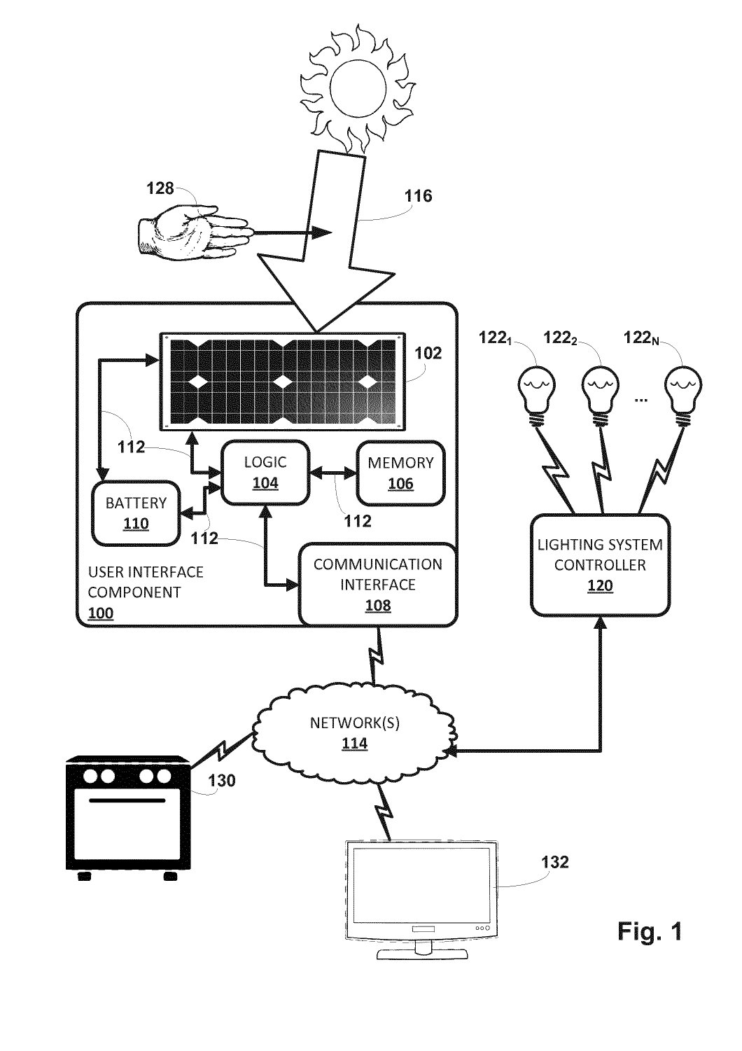

Referring to FIG. 1, in one embodiment, a user interface component 100 is depicted schematically as including an energy harvesting unit 102, which takes the form of a solar cell in this example. In some embodiments, user interface component 100 may be affixed to a surface of the appliance it is meant to control. In other embodiments, user interface component 100 may be mounted remotely from the appliance it is meant to control. Accordingly, user interface component 100 may take various form factors. For example, in some embodiments in which user interface component 100 is intended to facilitate operation of one or more light sources, user interface component 100 may take the form of a wall switch plate that is mountable to a surface such as a wall, and that is operable to wirelessly control one or more light sources. In other embodiments, user interface component 100 may take the form of a sticker substrate that is securable to a surface, e.g., using adhesives or hook and loop fasteners.

In various embodiments, user interface component 100 may include logic 104, memory 106, a communication interface 108, and a battery 110, all operably coupled via one or more buses 112. Logic 104 and memory 106 may take various forms that are described above. Communication interface 108 may be a wired or wireless communication interface that may employ a variety of communication technologies in order to transmit and/or receive data from remote locations. For example, in various embodiments, communication interface 108 may be configured to facilitate communication with various remote components directly and/or over one or more communications networks, here, designated by network 114, using well-known communications protocols including, by way of example and not limitation, GSM, GPRS, EDGE networking, Wi-Fi® or WiMax® (registered trademarks of the WiFi Alliance), and BLUETOOTH® (registered trademark of Bluetooth SIG, Inc.). While only a single communication interface 108 is depicted in FIG. 1, this is not meant to be limiting; any number of communication interfaces may be coupled with logic 104, and each may be configured to communicate using one or more of the various technologies described above.

Energy harvesting unit 102 may be configured to capture energy from one or more environmental stimuli and convert that captured energy into a different form (e.g., voltage in a battery) that may be used to power, for instance, components of user interface component 100. In the example of FIG. 1, energy harvesting unit 102 is a solar cell that is configured to capture sunlight 116 for conversion to voltage that may be stored in battery 110. Voltage stored in battery 110 may later be used to power various functions of user interface component 100, such as facilitating transmission and/or reception of data by communication interface 108.

Logic 104 may be configured to communicate with various appliances that are external to user interface component 100 via communication interface. For example, in various embodiments, logic 104 may communicate with a lighting system controller 120 that is configured to operate (e.g., by sending lighting control commands to) one or more individual lighting units 122_{1-N}. Additionally or alternatively, in some embodiments, logic 104 may communicate directly with lighting units 122_{1-N} directly, bypassing or omitting lighting system controller 120 altogether. Although not depicted, lighting system controller 120 may include various standard computing components such as processors, memory, communication interfaces (wired and/or wireless), input/output devices, power sources, and so forth. In FIG. 1, lighting system controller 120 is depicted as being in wireless communication (e.g., coded light, Zigbee, Bluetooth, Wi-Fi, etc.) with lighting units 122_{1-N}, but this is not meant to be limiting. In various embodiments, lighting system controller 120 may additionally or alternatively be in wired communication with lighting units 122_{1-N}.

However logic 104 communicates with lighting units 122_{1-N}, in various embodiments, logic 104 may be configured to transmit lighting control data to lighting units 122_{1-N} to cause lighting units 122_{1-N} to emit light having various selected properties. Properties of light emitted by lighting units 122_{1-N} that may be adjusted by logic 104 include but are not limited to hue, saturation, color, brightness, intensity, dynamic effects (e.g., blinking), and so forth.

In various embodiments, logic 104 may generate the lighting control data it transmits to lighting units 122_{1-N} (directly or via lighting system controller 120) based on one or more fluctuations detected in voltage generated by energy harvesting unit 102. As noted above, the detected current fluctuations may be caused by a corresponding fluctuation in light captured by energy harvesting unit 102. Logic 104 may then determine that the detected current fluctuation matches a predefined current fluctuation pattern associated with deliberate modulation of light captured by energy harvesting unit 102. In some embodiments, memory 106 may store one or more predefined current fluctuation patterns associated with adjustment of various operating parameters of lighting units 122_{1-N}. Logic 104 may be configured to compare the detected fluctuation in current to the one or more predefined current fluctuation patterns, and generate lighting control data based on the matching predetermined current fluctuation pattern. Then, logic 104 may transmit the lighting control data through communication interface 108 to lighting system controller 120 or directly to lighting units 122_{1-N}.

One way that a user can modulate light captured by energy harvesting unit 102 is to move an object such as the user's hand 128 between a source of artificial or natural light (e.g., the sun in FIG. 1) and energy harvesting unit 102, as indicated by the arrow. This will cause a corresponding fluctuation in current generated by energy harvesting unit 102 that may be detected by logic 104. Assuming the detected current fluctuation satisfies some criterion (e.g., is sufficiently abrupt, or matches a predefined current fluctuation pattern stored in memory 106), then logic 104 may generate one or more lighting control commands that are associated with satisfaction of the criterion. For example, in some embodiments, a first current fluctuation pattern may be stored in memory 106 in association with a first lighting control command (e.g., “turn lights on”), and a second current fluctuation pattern may be stored in memory in association with a second lighting control command (e.g., “turn lights off”).

Of course, more complex lighting control data may be generated based on user modulation of light harvested by energy harvesting unit 102. For example, in some embodiments, energy harvesting unit 102 may include a plurality of solar cells, each configured to generate current from captured light. Logic 104 may be configured to determine a direction of deliberate modulation of light captured by energy harvesting unit 102 based on currents generated by the plurality of solar cells. For example, a two-dimensional grid of discrete solar cells may be arranged on user interface component 100. As a user moves her hand across the multiple cells, a cascade of current fluctuations will be detected across successive solar cells. A direction of this cascade may be ascertained and used to determine what sort of lighting control commands should be generated. For example, a user could wave her hand one direction to dim the lights and the opposite direction to brighten the lights. Or, a user could move her hand in a particular direction to toggle through various light settings, such as color, intensity, dynamic effects, etc.

Also depicted in FIG. 1 are other appliances that may be controlled via modulation of light captured and harvested by energy harvesting unit 102. In this example, these other appliances include a “smart” oven 130 and a “smart” television 132. However, these are just two additional examples of appliances that may be controlled using techniques described herein. Other appliances that may be controlled using techniques described herein include but are not limited to garage doors, window blinds, heating, ventilation, and air conditioning (HVAC) equipment, plumbing equipment such as toilets, showers, and sinks, toasters, dishwashers, adjustable furniture (e.g., beds, chairs, etc.), and so forth. Instead of generating “lighting control data” for these appliances, logic 104 may more generally produce what will be referred to herein as “appliance control data,” which may include/encompass lighting control data.

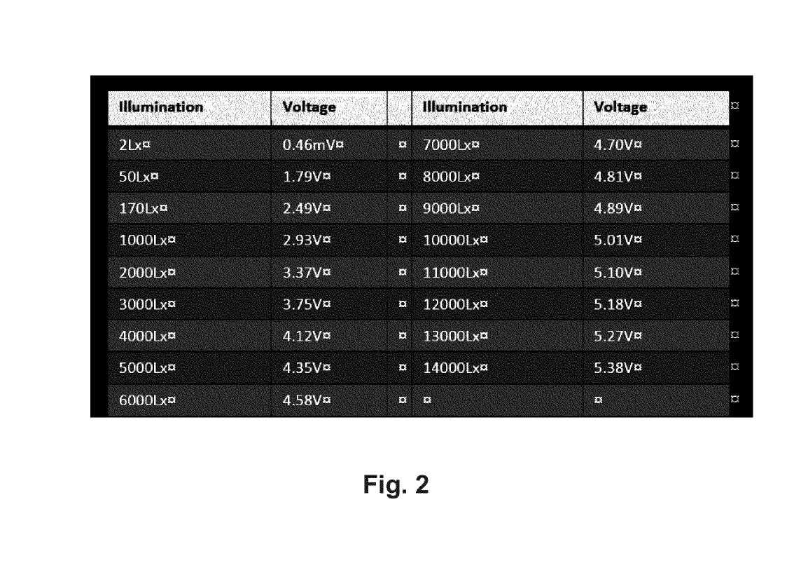

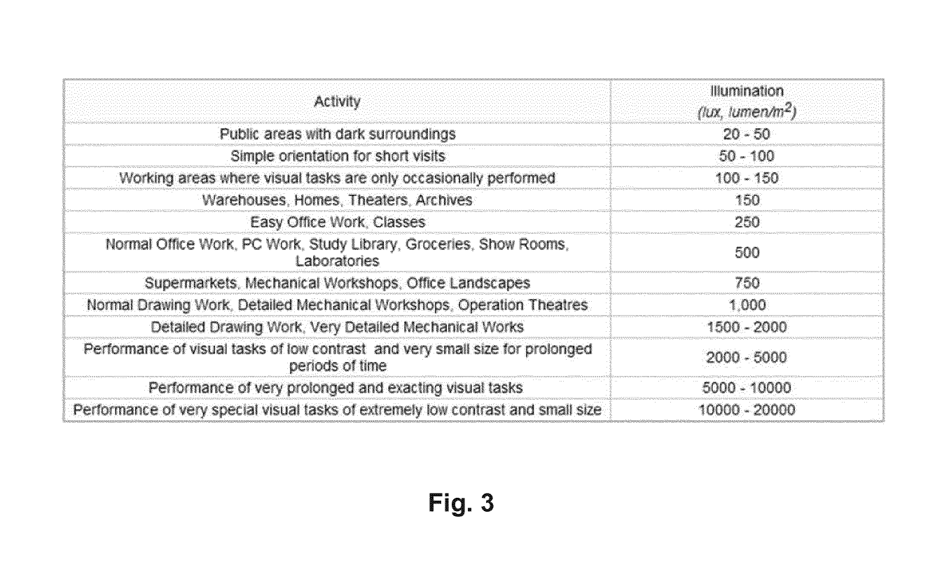

FIG. 2 depicts example experimental results of voltage that is generated at a solar cell when exposed to various ambient light levels. For example, at 2 Lx of light output, the solar cell produced 0.46 mV. At 3000 Lx of light output, the solar cell produced 3.75V. Any substantial deviation from the voltage values depicted in FIG. 2 caused by deliberate user modulation of captured light may be relatively easily detected by logic 104 and used to generate appliance control commands. FIG. 3 depicts a table that includes recommended guidelines for illumination while participating in various activities. For example, in supermarkets, it is recommended that there by 750 lux of illumination. In darkened rooms the light is usually above 200 lux, which is more than sufficient to power electronics such as logic 104 and communication interface 108 to generate and transmit appliance control data to one or more appliances.

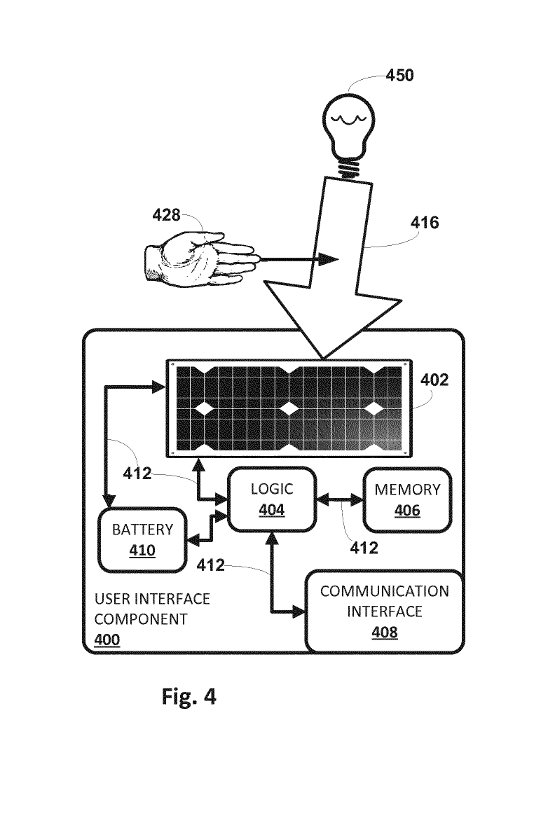

FIG. 4 depicts another embodiment of a user interface component 400. Many of the features of user interface component 400 are similar to those depicted in FIG. 1, except that they are labeled with “4XX” rather than “1XX,” and thus will not be described again. In this example, however, rather than harvesting sunlight from the sun, as was the case in FIG. 1 energy harvesting unit 402 harvests energy (i.e. light 416) from an artificial light source 450, in this case a lighting unit. The artificial light source 450 may be include one or lighting units and/or luminaires, such as those that are already present in a room. Otherwise, user interface component 400 may operate similarly (or even identically) to user interface component 100 of FIG. 1.

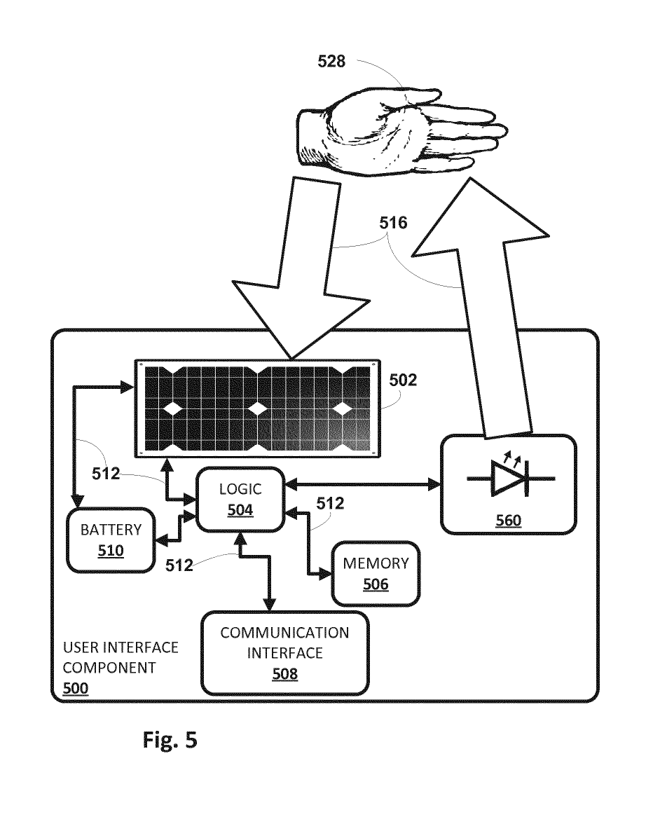

FIG. 5 depicts another alternative embodiment of a user interface component 500. Once again, many of the features of user interface component 500 are similar to those depicted in FIG. 1, except that they are labeled with “5XX” rather than “1XX,” and thus will not be described again. However, user interface component 500 includes a light source 560 operably coupled with logic 504. In this example, light source 560 is an LED-based light source, but this is not meant to be limiting, and other types of light sources, such as incandescent, fluorescent, halogen, and so forth, may be employed.

In various embodiments, logic 504 may be configured to cause light source 560 to emit light 516 in a direction away from energy harvesting unit 502. Consequently, the light 516 may not be harvested by energy harvesting unit 502 under normal circumstances. However, when an object such as a user's hand 528 passes into the path of light 516, that light may be reflected back towards energy harvesting unit 502. Accordingly, a user may move her hand to modulate how and/or when light is reflected towards energy harvesting unit 502. As was the case in the previously-described examples, this modulation of light may cause a corresponding fluctuation (e.g., an increase) in voltage generated by energy harvesting unit 502. The current fluctuation may be analyzed by logic 504 to generate appliance control data for transmission to one or more appliances (not depicted in FIG. 5).

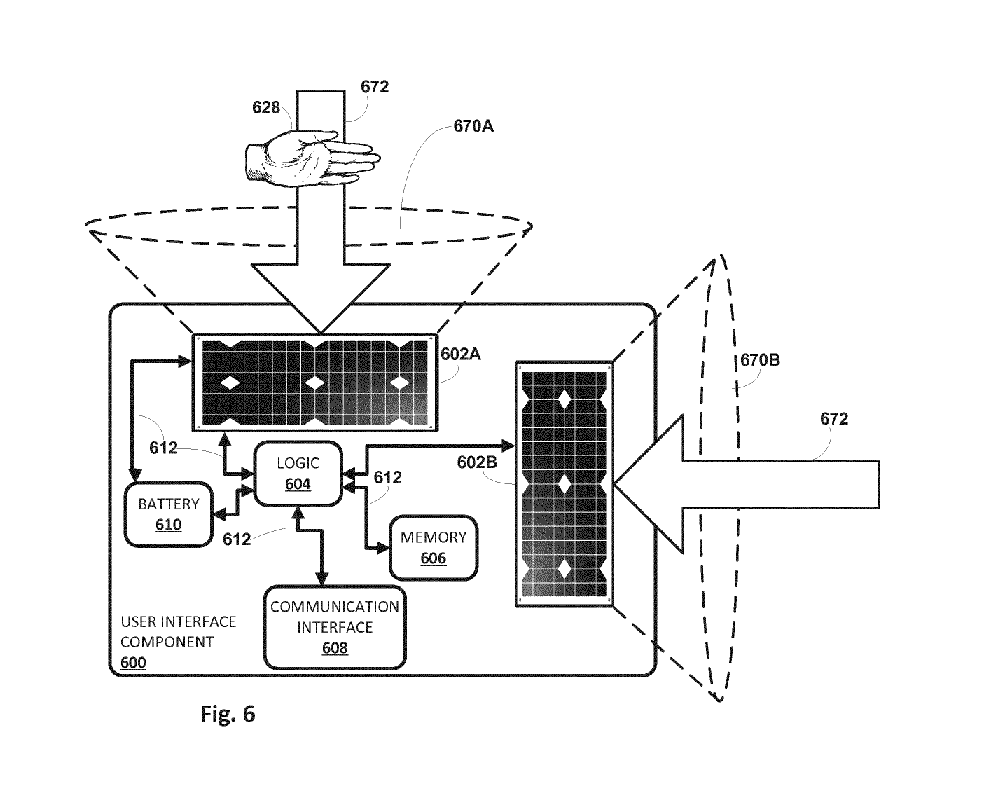

FIG. 6 depicts another embodiment of a user interface component 600 with features that are similar to those depicted in previously-described embodiments (and thus are not discussed again). However, the embodiment of FIG. 6 differs from previously-described embodiments in at least one respect. User interface component 600 includes multiple energy harvesting units, 602A and 602B. First energy harvesting unit 602A has a first field of view 670A that is pointed in a first direction (up in FIG. 6). Second energy harvesting unit 602B has a second field of view 670B pointed in a second direction (right in FIG. 6) that is different than first field of view 670A.

In various embodiments, one of first field of view 670A and second field of view 670B may be selected so the corresponding energy harvesting unit 602 continues to capture ambient light 672 uninterrupted while light captured by the other energy harvesting unit 670 is modulated by a user. For example, in FIG. 6, a user's hand 628 is depicted modulating ambient light 672 that would otherwise be captured by first energy harvesting unit 602A. If user interface component 600 is a wall-mounted switch plate, then first energy harvesting unit 602A may be pointed outwards from the wall. Meanwhile, second energy harvesting unit 602B continues to capture ambient light 672 uninterrupted by hand 628. For example, if user interface component 600 is a wall-mounted switch plate, then second energy harvesting unit 602B may be pointed upwards or to the side. In this sense, a user may more easily modulate light 672 captured by first energy harvesting unit 602A, which therefore may be referred to as an “operation energy harvesting unit.” By contrast, a user may not be able to easily modulate light 672 captured by second energy harvesting unit 602B, in which case second energy harvesting unit 602B may be may be referred to as a “reference energy harvesting unit.”

In various embodiments, logic 604 may be configured to compare current provided by an operation energy harvesting unit (e.g., 602A) to current provided by a reference energy harvesting unit (e.g., 602B), and generate appliance control data based at least in part on the comparison. For example, if there is a sudden increase or decrease in light captured at the operation energy harvesting unit (e.g., 602A), and no corresponding increase or decrease in light captured at the reference energy harvesting unit (e.g., 602B), that may suggest user modulation of light in a manner intended to cause generation of appliance control data. By contrast, a gradual increase or decrease in light captured simultaneously at both energy harvesting units may be interpreted simply as ambient light increasing or decreasing, e.g., at dawn or dusk.

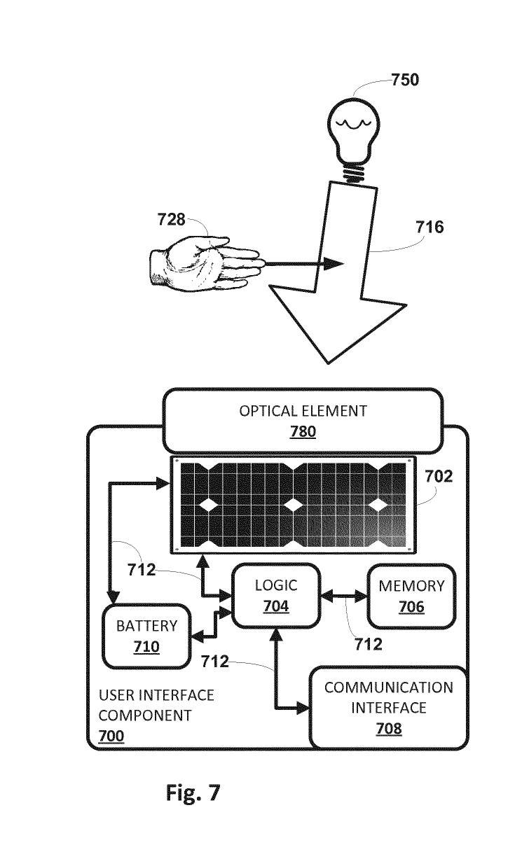

FIG. 7 depicts another alternative embodiment of a user interface component 700. Once again, many of the features of user interface component 700 are similar to those depicted in FIG. 1, except that they are labeled with “7XX” rather than “1XX,” and thus will not be described again. In this example, however, user interface component 700 includes an optical element 780 element positioned at least partially within a field of view (not specifically referenced in FIG. 7) of energy harvesting unit 702. In various embodiments, optical element 780 may be adjustable to alter a manner in which light 716 reaches energy harvesting component 780. In some embodiments, optical element 780 may be adjustable to amplify an increase or decrease in captured light caused by user modulation of light that reaches the energy harvesting unit.

For example, in some embodiments, optical element 780 may include one or more polarizing elements that may be rotated, e.g., relative to each other, to alter how light 716 reaches energy harvesting unit 702. In other embodiments, optical element 780 may include one or more shutters that may be adjusted to alter how light 716 reaches energy harvesting unit 702. In some embodiments, optical element 780 may be adjusted based on a mechanical state of user interface component 700. For example, a switch, knob, or dial (not depicted) on user interface component 700 may be physically manipulated to rotate one or more polarizing elements and/or to redirect one or more shutters.

In some embodiments, a portion of energy harvesting unit 702 (e.g., a discrete solar cell) may be pointed at sources of natural light such as doors or windows, and another portion of energy harvesting unit 702 (e.g., another discrete solar cell) may be pointed elsewhere so that it is not as greatly affected by changes in natural light. The latter energy harvesting unit may be used to power user interface component 700 and/or as a reference.

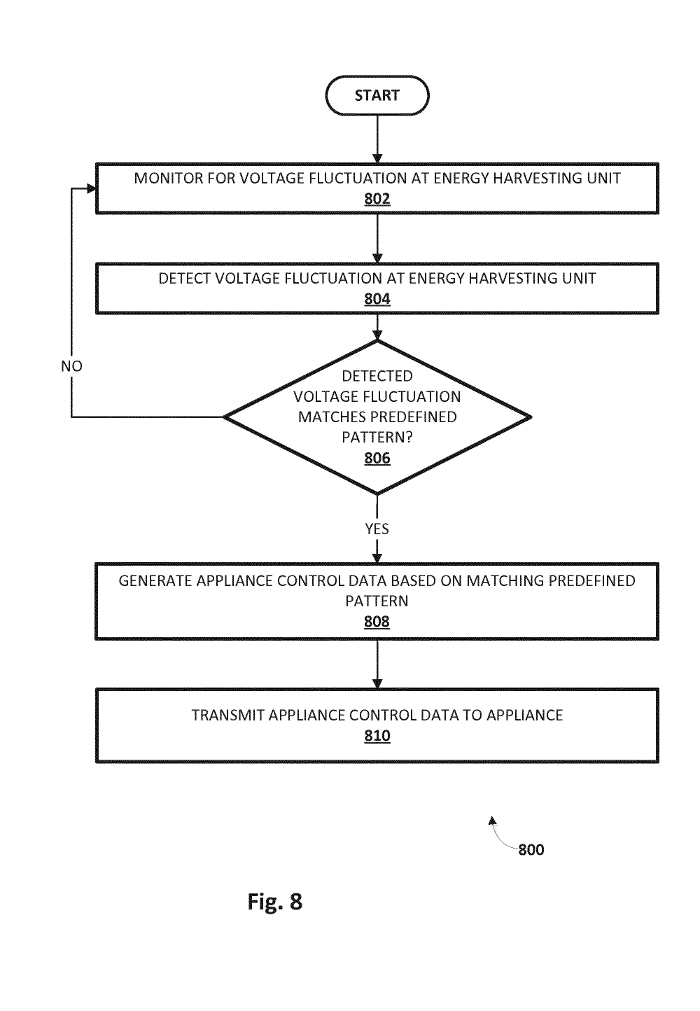

FIG. 8 depicts an example method 800 of controlling one or more appliances using an energy harvesting unit (e.g., 102, 402, 502, 602, 702), in accordance with various embodiments. While the operations are depicted in a particular order, this is not meant to be limiting. In various embodiments, various operations may be reordered, omitted, or added. Method 800 may begin at block 802 at which current generated by an energy harvesting unit is monitored (e.g., by logic 104, 404, 504, 604, 707) for fluctuations potentially caused by deliberate user modulation of captured light.

At block 804, a current fluctuation is detected, and method 800 proceeds to block 806. At block 806, it is determined whether the current fluctuation detected at block 804 matches a predefined current fluctuation pattern (e.g., stored in memory 106, 406, 506, 606, 706). More generally, in various embodiments, it may be determined whether the detected current fluctuation satisfies one or more criteria (e.g., sufficiently abrupt, etc.).

In order for detected current fluctuation to “match” a predefined current fluctuation pattern, it is not necessary that there is a precise match. Rather, there may be a match between a detected current fluctuation and a predefined current fluctuation pattern when the two are sufficiently similar, e.g., satisfying some predetermined similarity threshold. Suppose a predefined current fluctuation pattern includes two peaks (or valleys) of similar magnitude in relatively quick temporal succession. These peaks (or valleys) may correspond to a user passing her hand in front of an energy harvesting unit twice in succession, e.g., back and forth in a waving motion. Suppose a subsequent user later waves her hand in front of the energy harvesting unit twice in succession. Even if the subsequent user waves more slowly or quickly than a predefined current fluctuation pattern indicates, so long as the frequency of the detected current fluctuation is within a predetermined range and/or margin of error of the predefined current fluctuation pattern, there may be a match. If two predefined current fluctuation patterns are within a predetermined range or margin of error of a detected current fluctuation, then the predefined current fluctuation pattern that more closely matches the detected current fluctuation may be considered the match.

Referring back to FIG. 8, if the answer at block 806 is no, then method 800 returns to block 802. However, if the answer at block 806 is yes, then method 800 proceeds to block 808. At block 808, appliance control data (e.g., lighting control commands) may be generated based on the matching predefined current fluctuation pattern. For example, one predefined current fluctuation pattern may be associated with turning lights on. Another predefined current fluctuation pattern may be associated with turning lights off. Yet another predefined current fluctuation pattern may be associated with toggling through various light output settings, such as hue, color temperature, saturation, etc.

At block 810, the appliance control data generated at block 808 may be transmitted, e.g., via a communication interface (e.g., 108, 408, 508, 608, 708) to a remote appliance. If the remote appliance is a lighting unit or luminaire, the appliance control data may include lighting control data (e.g., lighting control commands) that may be transmitted directly to the lighting unit/luminaire or to a lighting system controller (e.g., 120) that operates the lighting unit/luminaire. More generally, in scenarios in which one or more appliances (e.g., lights, kitchen appliances, garage doors, windows, etc.) are networked into a so-called “smart home,” the appliance control data may be transmitted to a smart home “hub” than then transmits appropriate commands and/or data to appropriate appliances.

In addition to the gesture detection examples described above, techniques described herein may be used in other ways as well. For example, in some embodiments, an energy harvesting unit may be used as a tilt meter or detector. Changes in orientation of the energy harvesting unit relative to a source of light, such as the sun, may cause corresponding fluctuation in current provided by the energy harvesting unit. In some embodiments, gradual changes to ambient light may be adjusted for by averaging current readings from the energy harvesting unit over time. Additionally or alternatively, two energy harvesting units may be deployed. One may include a gravity-driven mechanism such as a shutter that moves in response to gravity. The other energy harvesting unit may be unobstructed, and may act as an ambient light reference.

As another example application, an energy harvesting unit may be exposed to the sun all day long. Much as a shadow of a sundial changes as the sun travels across the sky, the current produced by the energy harvesting unit may gradually change. These changes may be used for a variety of applications, such as updating an internal clock or timer each day.

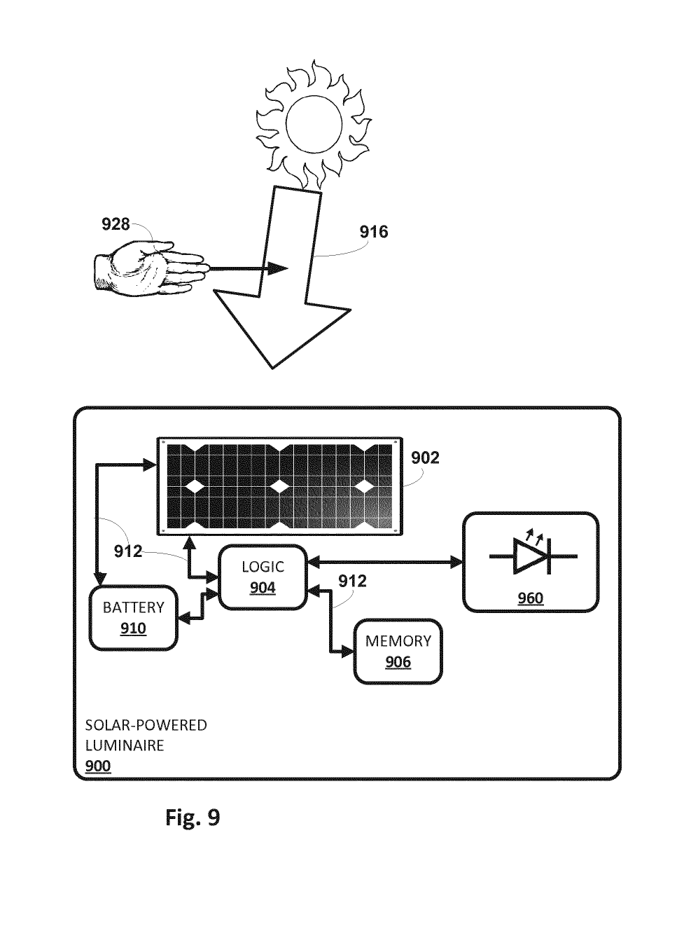

FIG. 9 demonstrates another application of disclosed techniques. In this example, a solar-powered luminaire 900 is configured with selected aspects of the present disclosure. Once again, many of the features of user interface component 900 are similar to those depicted in FIG. 1, except that they are labeled with “9XX” rather than “1XX,” and thus will not be described again. Solar-powered luminaire 900 may be deployed, for instance, outside of a home or building to provide (e.g., via one or more light sources 960) at least some illumination after dusk. Such solar-powered luminaries are commonly found along sidewalks and driveways, e.g., to aid a user in finding their way to an entrance of the building.

In FIG. 9, solar-powered luminaire 900 includes an energy harvesting unit in the form of a solar panel 902. In various embodiments, a user may interrupt light 916 that is captured by solar panel 902, e.g., using her hand 928 to make a gesture between the sun and solar panel 902. As described above, such interruptions may be manifested in fluctuations in current produced by solar panel 902. Logic 904 may be configured to determine one or more properties of light to be emitted by one or more light sources (e.g., LED 960) based on these detected current fluctuations. Logic 904 may then operate one or more light sources 960 to emit light having the selected properties, or in some cases to cease emitting light.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. It should be understood that certain expressions and reference signs used in the claims pursuant to Rule 6.2(b) of the Patent Cooperation Treaty (“PCT”) do not limit the scope of the claims.

1. An appliance control apparatus, comprising:
an energy harvesting unit to convert captured light into current;
logic operably coupled with the energy harvesting unit;
a communication interface; and
a light source operably coupled with the logic, wherein light emitted by the light source is captured by the energy harvesting unit,
wherein the logic is configured to:
detect a current fluctuation at the energy harvesting unit, the current fluctuation caused by a corresponding fluctuation in light captured by the energy harvesting unit;
determine that the detected current fluctuation matches a predefined current fluctuation pattern associated with deliberate modulation of light captured by the energy harvesting unit;
generate appliance control data based on the matching predefined current fluctuation pattern; and
transmit the appliance control data through the communication interface to one or more appliances.

2. The appliance control apparatus of claim 1, further comprising memory operably coupled with the logic and storing one or more predefined current fluctuation patterns, wherein the logic is configured to compare the detected fluctuation in current to the one or more predefined current fluctuation patterns.

3. The appliance control apparatus of claim 1, wherein the energy harvesting unit comprises an operation energy harvesting unit with a first field of view, and the appliance control apparatus further comprises a reference energy harvesting unit to convert captured light into current, wherein the reference energy harvesting unit has a second field of view that is different than the first field of view.

4. The appliance control apparatus of claim 3, wherein the second field of view is selected so that the reference energy harvesting unit continues to capture ambient light while light captured by the operation energy harvesting unit is interrupted.

5. The appliance control apparatus of claim 4, wherein the logic is further configured to:
compare current provided by the operation energy harvesting unit to current provided by the reference energy harvesting unit; and
generate appliance control data based at least in part on the comparison.

6. The appliance control apparatus of claim 1, wherein the appliance control data comprises lighting control commands, and the one or more appliances comprise one or more light sources.

7. The appliance control apparatus of claim 1, wherein the communication interface is a wireless communication interface.

8. The appliance control apparatus of claim 1, further comprising an optical element positioned at least partially within a field of view of the energy harvesting component, wherein the optical element is adjustable to alter a manner in which light reaches the energy harvesting component.

9. The appliance control apparatus of claim 8, wherein the optical element comprises one or more polarizers.

10. The appliance control apparatus of claim 8, wherein the optical element comprises one or more shutters.

11. (canceled)

12. The appliance control apparatus of claim 1, wherein the current fluctuation comprises a current increase that corresponds to an increase in light captured by the energy harvesting unit.

13. The appliance control apparatus of claim 12, wherein the increase in light captured by the energy harvesting unit is caused by light emitted by the light source and reflected from a user's hand.

14. The appliance control apparatus of claim 1, wherein the energy harvesting unit comprises a plurality of solar cells, each solar cell configured to generate current from captured light, and wherein the logic is configured to determine a direction of the deliberate modulation of light captured by the energy harvesting unit based on currents generated by the plurality of solar cells.

15. A system comprising:
one or more light sources;
a lighting system controller operably coupled with the one or more light sources; and
a solar panel user interface to generate current from captured light;
wherein light emitted by at least one of the light sources is captured by the solar panel user interface;
wherein the lighting system controller is configured to:
detect a current fluctuation at the solar panel user interface, the current fluctuation caused by a corresponding fluctuation in light captured by the solar panel user interface;
determine that the detected current fluctuation matches a predefined current fluctuation pattern associated with deliberate modulation of light captured by the solar panel user interface; and
cause the one or more light sources to emit light in accordance with the matching predetermined current fluctuation pattern.
